(19) United States
(12) Patent Application Publication
(10) Pub. No.: US 2026/0357450 A1
(43) Pub. Date: Nov. 12, 2026

(54) ELECTROLYSIS FACILITY WITH DEGASSING DEVICE AND ASSOCIATED METHOD

(71) Applicant: JOHN COCKERILL HYDROGEN BELGIUM, Seraing (BE)

(72) Inventor: Nicolas Maricau, Seraing (BE)

(73) Assignee: JOHN COCKERILL HYDROGEN BELGIUM, Seraing (BE)

(21) Appl. No.: 19/487,063

(22) PCT Filed: May 31, 2024
(86) PCT No.: PCT/EP2024/065087

§ 371 Date: Nov. 24, 2025

(30) Foreign Application Priority Data
May 31, 2023 (BE) 2023/5437

(51) Int. Cl. C25B 9/73; C25B 1/04; C25B 15/08

(52) U.S. Cl. CPC C25B 9/73; C25B 1/04; C25B 15/083

(57) ABSTRACT

A facility is provided that includes a degassing device (1) inclusive of a degassing chamber (14) provided with: an opening for a first pipe (11) for supplying a gas/liquid mixture; an opening for a liquid-discharge pipe (12) arranged below the level of the gas/liquid interface (15) of the degassing chamber (14); and an opening for a gas-discharge pipe (13) arranged above the level of the gas/liquid interface (15) of the degassing chamber (14). The degassing chamber (14) has one or more additional openings for one or more additional pipes (21, 22, 23, 24) for supplying a gas/liquid mixture, the additional pipes for discharging the gas/liquid mixture are connected to a pipe (11, 21, 22, 23, 24) for supplying a gas/liquid mixture to the degassing chamber (14), a flow-regulating device being configured on each of the supply pipes (11, 21, 22, 23).

The present invention pertains to the technical field of electrolysis and more particularly to an electrolysis facility for the production of dihydrogen (H₂) and dioxygen (O₂) by electrolysis of water. According to a first of its aspects, the invention relates to a facility for the production of dihydrogen and dioxygen by electrolysis of water. Another aspect of the invention relates to a degassing method.

### INDICATION OF THE PRIOR ART

The need to reduce greenhouse gas production and to utilize renewable energies is now well known. Dihydrogen is an alternative to hydrocarbons because it is a readily storable energy carrier, unlike electricity, and its oxidation releases a very large energy (285 kJ/mol).

There are several known ways of producing gaseous dihydrogen; the most advantageous is to electrolyze the water molecule, as this is a high-yield reaction that does not directly produce CO₂, unlike the heavily used processes of methane, coal and hydrocarbon reforming.

There are three main types of electrolyzers known for water electrolysis:
alkaline electrolyzers (AWE), which are characterized by the use of a liquid electrolyte that allows the transfer of hydroxyl ions (OH⁻) from the cathode to the anode;
high-temperature electrolyzers, whose electrolyte is a ceramic; and
membrane electrolyzers (PEM), whose electrolyte is a proton-conducting ion exchange membrane.

In all three cases, the system must be supplied with water of very high purity (supplying, in the case of alkaline electrolyzers, an electrolyte solution of sodium hydroxide (NaOH) or potassium hydroxide (KOH)). Although the remainder of the description, for reasons of brevity, will refer to an alkaline electrolyzer, it is appreciated that the present invention also applies to the membrane electrolyzer (for example, a proton exchange membrane).

According to the well-known process of the prior art, an electrolyte solution (known as the lye) is brought within a set of electrolytic cells (known as the electrolyzer stack) through a specific inlet. The electrolyte solution passes through the electrolyzer stack. Water is broken down into gaseous molecules of dihydrogen, H₂, at the cathode, and dioxygen, O₂, at the anode. A diaphragm usually separates the anode from the cathode so that, under normal conditions, the dihydrogen and dioxygen do not mix. The facility comprises an outlet for dihydrogen and electrolyte circulating on the cathode side (catholyte) and an outlet for dioxygen and electrolyte circulating on the anode side (anolyte). In other words, there are two separate streams, and so there is a gas-liquid separator dedicated to the separation of dihydrogen from the catholyte, and a gas-liquid separator for the separation of dioxygen from the anolyte. The liquid outlets of the two gas-liquid separators are then mixed before feeding the electrolyzer stack again. In both streams, at the outlet of the electrolyzer stack, the liquid phase (lye) is charged with gas bubbles. At the outlet of the gas-liquid separator, only a few gas bubbles remain in the lye evacuated through the lower orifice of the gas-liquid separator dedicated to the liquid phase, while the majority gas phase is extracted from the gas-liquid separator through the upper orifice of the gas-liquid separator. For various reasons, it is important to separate the gas from the lye. First of all, the more the gas is separated from the electrolyte, the greater the production of gas, which contributes to the good electrochemical yield of the process. Next, the H₂/O₂ mixture is highly explosive. If separation does not take place correctly, a significant amount of gas, commonly referred to as “residual gas”, is entrained at the liquid outlet of the gas-liquid separator. During the next circulation in the electrolyzer stack (the electrolyte rotates in a closed loop), some of this gas passes into the other compartment and therefore to the wrong side.

These gas-liquid separators, well known in the art, comprise a degassing chamber having an opening for a gas-liquid mixture supply pipe, an opening for a liquid discharge pipe arranged below the level of the gas-liquid interface of the degassing chamber, and an opening for a gas discharge pipe arranged above the level of the gas-liquid interface of the degassing chamber. Each of the outlets of the electrolyzer stack for the dihydrogen-lye and dioxygen-lye mixtures respectively is connected to such a gas-liquid separator. FIGS. 1 and 2 schematically depict known gas-liquid separators aligned respectively along a horizontal or vertical main axis A. Document FR-A1-2949479, for example, describes such gas-liquid separators. Another gas separator is known from document EP-A1-4001464. In this facility, the products of electrolysis are highly corrosive (alkaline) and brought to high temperatures. The degassing facility must therefore be able to withstand these extreme conditions, which requires the use of very expensive materials such as nickel alloys. This document proposes a solution whereby the gas-liquid mixture to be degassed is introduced in several fractions. The hotter fractions are introduced directly into the part of the degassing chamber above the gas-liquid interface while colder fractions are introduced into a channel circumscribing the degassing chamber. The gas-liquid mixture from the channel can pass into the degassing chamber via a separation element. The assembly thus makes it possible to cool the gas-liquid mixture in the degassing chamber.

The principle of extraction of gas bubbles from the liquid phase is based on the Archimedes principle. The efficiency of the separation depends primarily on gravity and on the difference in density between the liquid and gas phases, but also on the viscosity (friction of the gas bubbles in the liquid part). The gas-liquid mixture must therefore reside long enough in the degassing chamber to allow all of the gas bubbles to be extracted from the lye. In the remainder of the description, gas-liquid separators of this kind will be designated by the term gravity gas-liquid separators. These gravity gas-liquid separators are characterized by substantial dimensions. In some gas-liquid separators, equipment can be inserted to speed up separation (for example, a honeycomb structure) or to homogenize the flow and have a uniform residence time for all streamlines. Gas bubbles still present in the liquid phase can be quantitatively significant; in other words, not all the gas bubbles manage to be extracted from the liquid phase so as to be evacuated by an ad hoc discharge pipe on the upper or side wall of the degassing chamber. This poses a number of problems. As already indicated above, the output of the electrolyzer stack suffers from this loss of gas. In addition, in conventional electrolysis facilities, the two lye fractions discharged from the gas-liquid separator are combined and mixed in an intermediate tank before being fed back into the electrolyzer stack in a closed loop. Owing to incomplete separation, a potentially significant amount of residual dihydrogen and residual dioxygen may be fed back into the electrolyzer stack, so that the residual dioxygen is on the cathode side while the dihydrogen is directed to the anode. As already indicated, it is well known that the dihydrogen/dioxygen gas mixture is explosive even at a fairly low concentration and this situation is dangerous for personnel and the facility. The gases thus produced also have a very mediocre purity, which requires an additional purification step.

One solution to this problem is to increase the size of the gas-liquid separators, which in turn gives rise to new problems, related to the additional cost, the complexity of manufacturing and transporting these gas-liquid separators, and the increase in the size of the production works.

It would therefore be desirable to be able to provide an electrolysis facility comprising a degassing device that allows virtually complete degassing of the discharges (dihydrogen/lye and dioxygen/lye of the electrolytic cells). Ideally, a degassing device of this kind should be able to furnish the expected result when the system is operated at full load (high discharge flow rate) or at reduced load (low discharge flow rate).

Indeed, it should also be taken into account that gas-liquid separators in electrolyzers do not always produce dihydrogen and dioxygen at their nominal load (unlike similar systems for other industries or applications) and that the system must be efficient regardless of the amount of gas to be separated. This is because, when the volume of gas decreases, the purity of the gases goes down since proportionally the coalescence of the gas bubbles, which are larger and easier to extract, is not the same.

Another problem concerns the surface area taken up by the electrolysis facility. To be specific, in known devices, each electrolyzer stack is connected to a separate degassing device. This configuration therefore tends to result in the design of very large facilities. The inventor has observed that if it is attempted to supply a degassing device via the gas-lye outlet pipes of several electrolyzer stacks, the liquid contained in the degassing device is subjected to currents coming from several supply pipes in line with asymmetrical forces, leading to rotation of the flow (recirculation effect). Gas bubbles are trapped in this recirculation, which restricts their movement. The optimal flow, namely a uniform flow along the length of the gas-liquid separator, can no longer be ensured, which impairs separation performance. The phenomenon of recirculation in turn creates recirculation pockets. Gas bubbles present at the inlet of the gas-liquid separator at the height of the gas-liquid interface are drawn toward the lower part of the degassing device.

Ultimately, this phenomenon of recirculation within the gas-lye mixture causes the quantity of gas bubbles at the bottom of the gas-liquid separator to increase drastically, which means that the “residual” liquid phase, leaving the degassing device through the opening for the liquid discharge pipe located on the lower face of the device, contains more gas bubbles and therefore accentuates all the consequences described above with regard to the introduction of the residual gas at the liquid outlet of the degassing device into the electrolyzer stack. In other words, the gas bubbles cannot naturally follow the conventional path, first reaching the gas-liquid interface before being spontaneously extracted through the orifice located on the upper face of the gas-liquid separator.

The inventor therefore set about eliminating this phenomenon of recirculation that they had discovered.

### DISCLOSURE OF THE INVENTION

This aim is achieved by implementing an electrolysis facility comprising at least two electrolyzer stacks and a degassing device as defined in claim 1. To be specific, it has been observed that by dimensioning, aligning and orienting the supply pipes of the degassing device appropriately, it is possible to obtain better homogenization of the flow, in other words to eliminate or at least very significantly limit the formation of these recirculation currents, and that, quite surprisingly, it is possible to have supply pipes supplying lye-gas mixture coming from several electrolyzer stacks opening into a degassing chamber without negative consequences on the efficiency of gas-lye separation. As a result, it is possible to reduce the overall size of the electrolysis facility.

Advantageously, the supply pipes supplying gas-liquid mixture to the degassing chamber are present in an even number and are dimensioned, aligned and oriented in the degassing chamber identically in pairs. It has in fact been observed that it is not absolutely essential to ensure that all the supply pipes are configured identically to obtain the desired effect and that it is sufficient for the supply pipes to the degassing chamber to be coupled in pairs. In addition to the configurational aspect, this pairing corresponds to the fact that the supply pipes have identical diameters, gas flow rates and lye flow rates. To this end, the paired supply pipes are both connected to electrolyzer stacks producing the same gas flow rate and in which the circulating lye flow rate is similar while taking into account that the diameter of the supply pipes is identical. Even more advantageously, the supply pipes to the degassing chamber are paired in a linear progression starting from the central pair. This means that the central two pipes are paired and, starting from this central pair, each of the subsequent supply pipes is paired with the supply pipe with which it is symmetrical about the central pair.

According to another advantageous embodiment of the invention, the supply pipes supplying gas-liquid mixture to the degassing chamber are present in an odd number and are dimensioned, aligned and oriented in the degassing chamber identically in pairs, with a single central supply pipe. The concept of pairing defined above with an even number of supply pipes is also valid in the present case for an odd number of supply pipes. Even more advantageously, the supply pipes to the degassing chamber are paired in a linear progression starting from the single central pipe. This means that the central pipe is not paired and, starting from this central pipe, each of the subsequent supply pipes is paired with the supply pipe with which it is symmetrical about the central pipe.

According to a preferred embodiment of the invention, the gas-liquid mixture supply pipes are aligned along a substantially vertical axis in a wall of the degassing chamber and open into the degassing chamber along a substantially vertical axis.

According to a preferred embodiment of the invention, the gas-liquid mixture supply pipes are aligned along a substantially horizontal axis in a wall of the degassing chamber and open into the degassing chamber along a substantially horizontal axis.

According to another embodiment of the invention, the supply pipes supplying gas-liquid mixture to the degassing chamber open into the degassing chamber orthogonally to the wall.

According to another preferred embodiment of the invention, the supply pipes supplying gas-liquid mixture to the degassing chamber are equidistant, at least in pairs (in other words, the paired supply pipes are arranged symmetrically about the central pair).

According to another variant of the invention, the supply pipes supplying gas-liquid mixture to the degassing chamber open into the degassing chamber at an identical distance from the wall, at least in pairs (in other words, the paired supply pipes open into the degassing chamber at a distance from the wall symmetrically about the central pair).

According to another of its aspects, the invention relates to a degassing method as defined in claim 8.

Advantageously, at least some of the supply pipes supplying gas-liquid mixture to the degassing chamber are present in an even number and are dimensioned, aligned and oriented in the degassing chamber identically in pairs and said some of the supply pipes are supplied with flows having identical properties in pairs.

Even more advantageously, the supply pipes for supplying gas-liquid mixture to the degassing chamber are supplied with flows having a lye flow rate, a gas flow rate, a temperature and a pressure that are identical in pairs.

Preferably, the facility is configured such that the fastest jets are furthest from the central pair of supply pipes and the slowest jets come from the central pair. Even more preferably, the paired pairs of supply pipes follow a progression whereby the jet velocity increases from the center outward.

### BRIEF DESCRIPTION OF THE FIGURES

The invention will now be described by means of the figures, which have no purpose other than that of illustrating the present invention. In these figures, schematically:

FIG. 1 depicts a degassing device according to the prior art

FIGS. 2 and 3 depict degassing devices according to the invention

FIGS. 4 to 8 depict details of the wall of the degassing chamber of the degassing device showing the configuration of the supply pipes

FIG. 9 depicts a degassing device according to the invention, seen from above

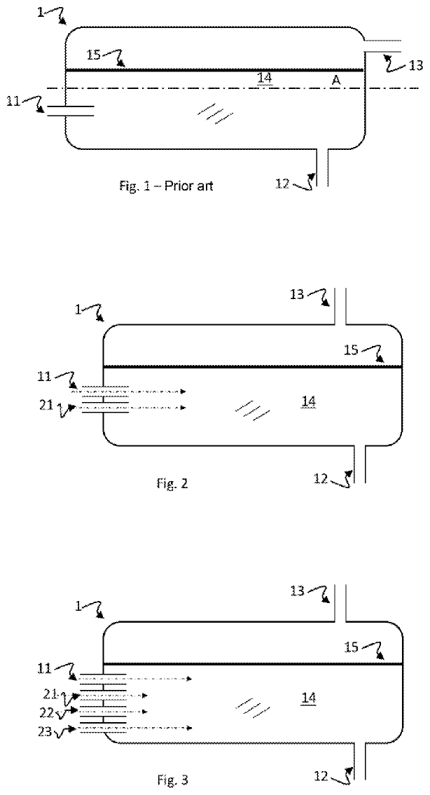

FIGS. 1 to 9 depict various degassing devices 1. All contain a degassing chamber 14. For example, gas-water or gas-lye. The gas may be dihydrogen or dioxygen. The degassing chamber 14 is supplied by a supply pipe 11 for the gas-liquid mixture coming from the electrolyzer stack. In some cases (not shown in the figures), the degassing chamber 14 can also be supplied with gas-liquid mixture coming from the liquid discharge pipe 12 of the degassing chamber 14 by means of a loop controlled by a valve, if a sensor has detected that the quantity of gas present in the discharge from the degassing chamber 14 was greater than a predetermined value. The degassing chamber 14 also comprises a pipe for discharge of gas, which can then either be discharged from the facility or reunited with the same gas from the electrolyzer stack. It will be noted that the gas discharge pipe 13 is always arranged above the gas-liquid interface 15. It may be located, for example, in the upper wall or in the or a side wall of the degassing chamber 14. Similarly, the liquid discharge pipe 12 is always arranged below the gas-liquid interface 15. It may be located, for example, in the lower wall (bottom wall) or in the or a side wall of the degassing chamber 14. The precise location of the discharge pipe 12 or 13 is not critical. As can be seen, however, in all the cases shown, the discharge pipe 12 or 13 has been arranged on the opposite side to, that is to say at the furthest distance from the supply pipe 11 of the degassing chamber 14, in order to allow a longer path for the liquid in the degassing device 1. The degassing device 1 may be arranged along a horizontal (FIGS. 1 to 3) or vertical (not shown) axis A, depending on structural requirements, for example.

The degassing devices 1 according to the invention depicted in FIGS. 2 to 9 show at least one additional supply pipe 21 through which the degassing chamber 14 is supplied with gas-liquid mixture. The degassing chamber 14 is therefore supplied with gas-liquid mixture by the two supply pipes 11 and 21. FIGS. 4 to 9 also show other additional supply pipes 22 and 23 (and 24 in FIG. 8) through which the degassing chamber 14 is supplied with gas-liquid mixture. The degassing chamber 14 of the device in FIGS. 4 to 7 and 9 is therefore supplied with gas-liquid mixture by the four supply pipes 11, 21, 22 and 23 and that in FIG. 8 by the five supply pipes 11, 21, 22, 23 and 24. The configurations could be reversed or even further gas-liquid mixture supply pipes could be added to the degassing chamber 14.

FIG. 2 therefore shows a degassing device 1 with two supply pipes 11, 21 for gas-lye mixture. As can be seen, the two supply pipes 11, 21 open into the same wall of the degassing chamber 14. They are aligned along a substantially vertical axis and open into the degassing chamber 14 at a substantially identical distance from the wall. As can also be seen, the two supply pipes 11, 21 open orthogonally to the wall of the degassing chamber 14 and have symmetrical flows (dotted arrow). This makes it possible to obtain flows producing a homogeneous circulation of the liquid in the degassing chamber 14 (i.e. substantial elimination of any recirculation current) following the pairing of the supply pipes 11 and 21. As a result, residual gas bubbles from the lye-gas mixture are not trapped in recirculation pockets and can escape from the liquid phase, thus achieving good separation. Note that the configuration shown in FIG. 3 is also particularly advantageous.

FIG. 3 thus shows a degassing device 1 with four supply pipes 11, 21, 22 and 23 for gas-lye mixture. As can be seen, the four supply pipes 11, 21, 22 and 23 open into the same wall of the degassing chamber 14, paired as follows: 11 with 23 and 21 with 22. They are aligned along a substantially vertical axis and open into the degassing chamber 14 at a substantially identical distance from the wall. As can also be seen, the four supply pipes 11, 21, 22 and 23 open orthogonally to the wall of the degassing chamber 14. The pair of supply pipes 21 and 22 constitute the central pair.

FIGS. 4 to 7 each show the details of a different configuration of the supply pipes 11, 21, 22 and 23 opening into the degassing chamber 14. These Figs. show four supply pipes opening into the degassing chamber 14, but the invention could just as easily have been illustrated with six, eight, ten, etc. supply pipes in accordance with the principles illustrated. In other words, the inventor has clearly demonstrated that, regardless of the geometric configuration proposed (even or odd number of supply pipes opening into the degassing chamber 14), the paired supply pipes are supplied with flows having identical properties.

In all these Figs., the supply pipes 11, 21, 22 and 23 open into the degassing chamber 14. In FIGS. 4 to 6, the supply pipes 21, 22 of the central pair are relatively close and the supply pipes 11, 23 of the outer pair open on either side of the central pair 21, 22 at a distance from the nearest supply pipe of the central pair which is further than that between the two supply pipes of the central pair. FIG. 4 shows a configuration in which the four supply pipes open into the degassing chamber 14 at an identical distance from the wall. FIG. 5 shows a configuration in which the two supply pipes of the central pair open at a greater distance from the wall than the two supply pipes of the outer pair, and FIG. 6 shows the reverse configuration. FIG. 7 shows a configuration in which the supply pipes 21, 22 of the central pair are relatively far apart and the supply pipes 11, 23 of the outer pair open on either side of the central pair 21, 22 at a distance from the nearest supply pipe of the central pair which is nearer than that between the two supply pipes of the central pair.

In order to allow homogeneous circulation of the liquids in the degassing device 1, it is also possible to provide in the electrolysis facility for a flow regulating device (not shown) to be configured on each of the supply pipes 11, 21, 22, 23 such that the jets injected into the degassing chamber 14 have substantially identical velocities, at least in pairs.

FIG. 8 shows an embodiment in which, in addition to the paired supply pipes 11, 21, 22 and 23, the device comprises an additional supply pipe 24 which is central.

FIG. 9 shows another embodiment of the degassing device in which the supply pipes 11, 21, 22 and 23 which open into the degassing chamber are aligned along a substantially horizontal axis.

### LIST OF DRAWING REFERENCES

1 Degassing device
11 Gas-liquid mixture supply pipe
12 Liquid discharge pipe
13 Gas discharge pipe
14 Gas-liquid separation chamber
15 Gas-liquid interface
21 Additional supply pipe
22 Additional supply pipe
23 Additional supply pipe
24 Additional supply pipe

1. An electrolysis facility comprising at least two electrolyzer stacks and a degassing device (1) comprising a degassing chamber (14) having
an opening for a first gas-liquid mixture supply pipe (11);
an opening for a liquid discharge pipe (12) arranged below the level of the gas-liquid interface (15) of the degassing chamber (14);
an opening for a gas discharge pipe (13) arranged above the level of the gas-liquid interface (15) of the degassing chamber (14);
the degassing chamber (14) comprising
one or more additional opening(s) for one or more additional gas-liquid mixture supply pipe(s) (21, 22, 23, 24), wherein each of the gas-liquid mixture discharge pipes from each of the electrolyzer stacks is connected to a supply pipe (11, 21, 22, 23, 24) for supplying gas-liquid mixture to the degassing chamber (14), a flow regulating device being configured on each of the paired supply pipes (11, 21, 22, 23) such that the jets injected into the degassing chamber (14) have substantially identical velocities, at least in pairs.

2. The electrolysis facility as claimed in claim 1, wherein the pairs of supply pipes (11, 21, 22, 23) supplying gas-liquid mixture to the degassing chamber (14) are paired in a linear progression starting from the most central pair (21, 22).

3. The electrolysis facility as claimed in claim 1, wherein an additional supply pipe (24) is arranged at a center of the paired supply pipes (11, 21, 22, 23).

4. The electrolysis facility as claimed in claim 1, wherein the supply pipes (11, 21, 22, 23, 24) supplying gas-liquid mixture to the degassing chamber (14) are aligned along a substantially vertical or horizontal axis in a wall of the degassing chamber (14).

5. The electrolysis facility as claimed in claim 4, wherein the supply pipes (11, 21, 22, 23, 24) supplying gas-liquid mixture to the degassing chamber (14) open into the degassing chamber (14) orthogonally to the wall.

6. The electrolysis facility as claimed in claim 3, wherein the paired supply pipes (11, 21, 22, 23) supplying gas-liquid mixture to the degassing chamber (14) are equidistant with respect to the center, at least in pairs.

7. The electrolysis facility as claimed in claim 4, wherein the paired supply pipes (11, 21, 22, 23) supplying gas-liquid mixture to the degassing chamber (14) open into the degassing chamber (14) at an identical distance from the wall, at least in pairs.

8. A degassing method for degassing a gas-liquid mixture in an electrolysis facility as claimed in claim 1, wherein
a part of the gas-liquid mixture is introduced through the first supply pipe (11) into the degassing chamber (14) of the degassing device,
the liquid is discharged from the degassing chamber (14) through a liquid discharge pipe (12) arranged below the level of the gas-liquid interface (15) of the degassing chamber (14);
the gas is discharged from the degassing chamber (14) through a gas discharge pipe (13) arranged above the level of the gas-liquid interface (15) of the degassing chamber (14);
one or more other part(s) of the gas-liquid mixture is (are) introduced through one or more additional supply pipe(s) (21, 22, 23, 24) supplying gas-liquid mixture to the degassing chamber (14),
characterized in that the gas-liquid mixture is injected into the degassing chamber (14) through the supply pipes (11, 21, 22, 23, 24) with substantially identical velocities, at least in pairs.

9. The degassing method as claimed in claim 8, wherein
at least some of the supply pipes (11, 21, 22, 23, 24) supplying gas-liquid mixture to the degassing chamber (14) are present in an even number and are dimensioned, aligned and oriented in the degassing chamber (14) identically in pairs and wherein said some of the supply pipes (11, 21, 22, 23, 24) are supplied with flows having identical properties in pairs.

10. The degassing method as claimed in claim 9, wherein
the supply pipes (11, 21, 22, 23, 24) for supplying gas-liquid mixture to the degassing chamber (14) are supplied with flows having a lye flow rate, a gas flow rate, a temperature and a pressure that are identical in pairs.

11. The degassing method as claimed in the claim 10, wherein the paired pairs of supply pipes follow a progression whereby the jet velocity increases from the central pair to the outermost pair.
